(19) United States
(12) Patent Application Publication
(10) Pub. No.: US 2007/0153432 A1
(43) Pub. Date: Jul. 5, 2007

(54) Magnetic head

(75) Inventors: Rachid Sbiaa, Tokyo (JP); Isamu Sato, Tokyo (JP); Haruyuki Morita, Tokyo (JP)

Correspondence Address: OLIFF & BERRIDGE, PLC, P.O. BOX 19928, ALEXANDRIA, VA, 22320, US

(73) Assignees: TDK CORPORATION, Tokyo (JP); KABUSHIKI KAISHA TOSHIBA, Tokyo (JP)

(21) Appl. No.: 11/319,951

(22) Filed: Dec. 29, 2005

(51) Int. Cl. G11B 5/33

(52) U.S. Cl. 360/324.11

(57) ABSTRACT

A magnetic head is provided, which includes a magnetoresistive effect element having a pinned layer and a free layer and can sufficiently suppress noise induced by spin transfer even for high current density. The magnetic head includes the magnetoresistive effect element which comprises: a first pinned layer; a first spacer layer made of an insulating material; a free layer having a magnetization direction changeable in accordance with an external magnetic field; a second spacer layer that is conductive; and a second pinned layer, wherein those layers are stacked in that order. A magnetization direction of the first pinned layer is substantially fixed in a direction perpendicular to a stacked direction, and a magnetization direction of the second pinned layer is fixed to be opposite to the magnetization direction of the first pinned layer.

### BACKGROUND OF THE INVENTION

1. Field of the Invention

The present invention relates to a magnetic head used for reproducing the data stored on a hard disk, for example.

2. Description of the Related Art

In recent years, magnetic recording density in a hard disk has rapidly increased. Thus, needs for a compact high-sensitive magnetic head has also increased in order to follow the increase of the magnetic recording density. Recent read heads use a tunneling magnetoresistive (TMR) effect element which typically includes a pinned layer having a substantially fixed magnetization direction, a spacer layer made of an insulating material, and a free layer having a magnetization direction that can be changed in accordance with an external magnetic field, (see Japanese Patent Laid-Open Publications Nos. 2001-345497and 2002-57380, for example).

In the TMR element, a resistance value of a sense current flowing in a direction in which those layers are stacked becomes minimum when the magnetization direction of the free layer is parallel to that in the pinned layer, and becomes maximum when the magnetization direction of the free layer is anti-parallel to that in the pinned layer. The read head sensitivity is proportional to the difference between the maximum resistance value and the minimum resistance value.

Electrons among that of the sense current, of which spin direction is same as that of the pinned layer, pass through the pinned layer. On the other hand, electrons with the opposite spin direction are scattered on the pinned layer. In other words, in spin valve case, the pinned layer acts as source of polarization. The electrons having the thus same spin direction pass through the free layer, thereby sometimes causing instability of magnetization of the free layer to change the magnetization direction depending on the sense current density, the free layer magnetization magnitude, its thickness and other properties. This phenomenon is known as a spin-transfer effect. It has been predicted and observed experimentally that spin transfer can change the magnetization direction of a ferromagnetic layer or generate spin waves, (see S.I. Kiselev et al., “Microwave oscillations of a nanomagnet driven by a spin-polarized current”, Nature, (2003) Vol. 425, p. 380-383, for example). When the magnetization direction of the free layer is changed by the external magnetic field, a noise is caused due to excitations of free layer magnetization by the above spin-transfer effect in some cases. For magnetoresistive head with relatively large size, corresponding to a current density of below 10⁷ A/cm², the level of that noise is usually at an ignorable level.

However, as the size of the magnetoresistive effect element is reduced, the noise becomes larger and time needed for free layer magnetization to stabilize becomes longer, so that the noise level sometimes reaches an unacceptable level in some cases.

Increase of density of the sense current with the size reduction of the magnetoresistive effect element enhances the spin-transfer effect so as to cause the above phenomenon.

Besides the efforts to increase the recording density of hard-disk, there is also a need for reading the recorded data at high frequency (in a short period). This means that a magnetization of the free layer (sensing layer) should reach its equilibrium state in a short time when an external field is applied such media field for example. For a hard disk, it is assumed that the highest frequency during recording and reproduction is increased up to about 1 to about 5 GHz, for example. In this case, the free layer magnetization convergence time should be shorter than 6 ns, corresponding to a frequency of 1 GHz (i.e. 2π/1 GHz=6.28ns). However, from it was found that the convergence time of the free layer magnetization was approximately 10 ns when an area A of a cross-section of the free layer of the magnetoresistive effect element (that is perpendicular to the stacked direction) was 8000 nm² (e.g., 100 nm×80 nm) and the convergence time of the free layer magnetization was longer than 10 ns when the area A was smaller than 8000 nm², from micromagnetic simulation, as shown in FIG. 5. Moreover, it is estimated that the convergence time of free layer magnetization requires several tens of nanoseconds when the area A is smaller than 5000 nm².

### SUMMARY OF THE INVENTION

In view of the foregoing problems, various exemplary embodiments of the invention provide a magnetic head which includes a magnetoresistive effect element having a pinned layer and a free layer and can sufficiently suppress a noise generated by spin transfer effect even for high current density.

According to various exemplary embodiments of the present invention, a magnetic head including a magnetoresistive effect element is provided. The magnetoresistive effect element includes: a first pinned layer; a first spacer layer made of an insulating material; a free layer having a magnetization direction changeable in accordance with an external magnetic field; a second spacer layer that is conductive; and a second pinned layer. These layers are stacked in that order. A magnetization direction of the first pinned layer is substantially fixed along a direction perpendicular to a stacked direction in which these layers are stacked. A magnetization direction of the second pinned layer is fixed to be opposite to the magnetization direction of the first pinned layer.

The principle of suppressing a noise in the magnetic head by providing the magnetoresistive effect element having the above structure is not necessarily clear. However, the principle is generally considered as follows.

In a case where spin directions of electrons in a sense current are aligned in the upward direction when those electrons pass through the first pinned layer, for example, the electrons having the thus same spin direction pass through the free layer. On the other hand, electrons with the opposite (down) spin direction travel toward the free layer from the second pinned layer in which the magnetization direction is fixed to be opposite to the magnetization direction of the first pinned layer. In this manner, the electrons having the up-spin direction are supplied to the free layer from one side and down-spin electrons are supplied to the free from the other side. Thus, a spin-transfer effect in the free layer is reduced or canceled and a noise caused by oscillation of the magnetization of the free layer is suppressed.

Accordingly, various exemplary embodiments of the invention provide

a magnetic head comprising a magnetoresistive effect element, the magnetoresistive effect element including:

a first pinned layer;

a first spacer layer made of an insulating material;

a free layer having a magnetization direction changeable in accordance with an external magnetic field;

a second spacer layer that is conductive; and a second pinned layer, these layers are stacked in that order, wherein:

a magnetization direction of the first pinned layer is substantially fixed along a direction perpendicular to a stacked direction in which these layers are stacked; and

a magnetization direction of the second pinned layer is fixed to be opposite to the magnetization direction of the first pinned layer.

According to the present invention, a magnetic head with reduced spin transfer noise can be achieved, which includes a magnetoresistive effect element having a pinned layer and a free layer even when a cross-sectional area of the free layer of the magnetoresistive effect element is, for example, 8000 nm² or less.

### BRIEF DESCRIPTION OF THE DRAWINGS

FIG. 1 is a schematic side view showing the structure of a magnetic head according to a first exemplary embodiment of the present invention;

FIG. 2 is a schematic cross-sectional side view showing the structure of a magnetic head according to a second exemplary embodiment of the present invention;

FIG. 3 shows a graph of a relationship between the free layer magnetization in direction perpendicular to air bearing surface (ABS) and time according to the first exemplary embodiment of the present invention in Simulation Example 1;

FIG. 4 shows a graph of a relationship between the free layer magnetization in direction perpendicular to air bearing surface (ABS) and time according to the first exemplary embodiment of the present invention in Simulation Example 2; and

FIG. 5 shows a graph of a relationship between the free layer magnetization in direction perpendicular to air bearing surface (ABS) and time of Comparative Example in Simulation Example 3.

### DETAILED DESCRIPTION OF THE PREFERRED EMBODIMENTS

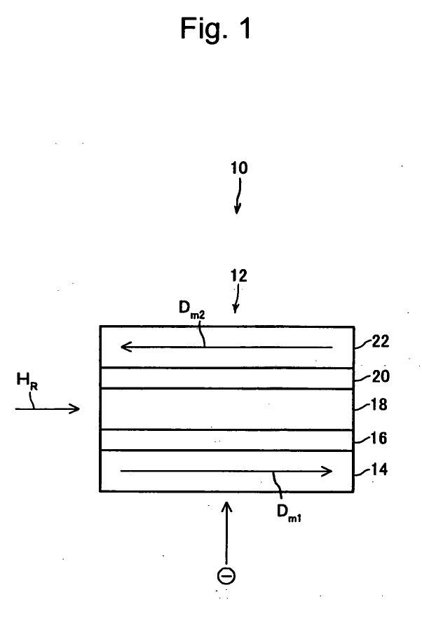

A magnetic head 10 according to a first exemplary embodiment of the present invention includes a magnetoresistive effect element 12, as shown in FIG. 1. The magnetic head 10 has a feature in the structure of the magnetoresistive effect element 12. Other structure of the magnetic head 10 except for the magnetoresistive effect element 12 does not seem necessary for understanding of the first exemplary embodiment and is therefore omitted here.

The magnetoresistive effect element 12 includes a first pinned layer 14, a first spacer layer 16 made of an insulating material, a free layer 18 having a magnetization direction that can be changed in accordance with a reproduction magnetic field HR (external magnetic field), a second spacer layer 20 that is conductive, and a second pinned layer 22. Those layers are stacked in that order. A magnetization direction Dm₂ in the first pinned layer 14 is substantially fixed in a direction perpendicular to a stacked direction in which those layers are stacked, and a magnetization direction Dm2 in the second pinned layer 22 is fixed to be opposite to the magnetization direction Dₘ₁ in the first pinned layer 14.

The first pinned layer is made of ferromagnetic material. Exemplary structures of the first pinned layer 14 include a single-layer structure consisting of a single ferromagnetic layer, a synthetic structure (that is formed by at least two ferromagnetic layers that are coupled antiferromagnetically to each other while those ferromagnetic layers are separated by a nonmagnetic spacer suchas Ru, Rh, Ir, Cr, Cu), and a multilayer structure including two or more ferromagnetic layers, e.g., CoFe/NiFe. A ferromagnetic layer represented by “CoFe/NiFe” means a bi-layer structure in which a CoFe layer portion substantially composed of Co and Fe and a NiFe layer portion substantially composed of Ni and Fe are stacked.

Examples of a material for the ferromagnetic layer include CoFe, CoFeB, NiFe, CoNi, CoFeNi, CoMnAl, NiMnSb, materials substantially composed of Co, Cr, Fe, or Al in combination such as Co₂Cro_{0.6}Fe_{0.4}Al; materials substantially composed of Co, Cr, and Al such as Co₂Cr_{0.6}Al; materials substantially composed of Co, Mn and Al such as Co₂MnAl; materials substantially composed of Co, Fe and Al such as Co₂FeAl; and materials substantially composed of Co, Mn and Ge such as Co₂MnGe or the like.

Incidentally, an antiferromagnetic layer maybe provided to fix the magnetization direction of the first pinned layer 14 in contact with the first pinned layer 14 if necessary. Examples of a material for the antiferromagnetic layer include alloys containing Mn for example PtMn, IrMn, FeMn or PtPdMn.

Exemplary insulating material for the first spacer layer 16 include Al₂O₃, TiO₂, MgO,and materials containing at least one of them.

It is preferable that a thickness tₛ₁, (nm) of the first spacer layer 16 satisfies 0<t_{s1≦}1.

As a material for the free layer 18, the same magnetic material as that for the first pinned layer 14 can be used. A magnetic field bias can be applied to the free layer 18 from hard (not shown) in a direction that is perpendicular to both the stacked direction and the magnetization direction of the first pinned layer 14. Thus, of the free layer 18 can have a mono-domain magnetic structure to reduce Barkhausen noise.

Exemplary materials for the second spacer layer 20 include Cu, Ag, Au, Cr, and materials containing at least one of those elements.

It is preferable that a thickness tₛ₂ (nm) of the second spacer layer 20 satisfy 2≦t_{s2≦}4.

The second pinned layer 22 is made of ferromagnetic material like the first pinned layer 14. An antiferromagnetic layer may be provided to fix the magnetization direction of the second pinned layer 22 during reading process in contact with the second pinned layer 22 if necessary.

The second pinned layer 22 can have the same structure as that of the first pinned layer 14. However, materials for the second pinned layer 22 and the antiferromagnetic layer coupled antiferromagnetically with the second pinned layer 22 have different blocking temperatures from those of the materials for the first pinned layer 14 and the antiferromagnetic layer coupled antiferromagnetically with the first pinned layer 14. The use of the antiferromagnetic layers having different blocking temperatures can allow the first pinned layers 14 and the second pinned layer 22 to be magnetized in opposite directions to each other under different temperature conditions.

It is preferable that a thickness t_{P2} (nm) of the second pinned layer 22 satisfy 1≦t_{P2≦}4.

An operation of the magnetic head 10 is now described.

A sense current is supplied to the magnetic head 10 in such a manner that electrons flow in the magnetoresistive effect element 12 in a direction from the first pinned layer 14 to the second pinned layer 22. The majority of electrons which passed the first pinned layer 14 has the same spin direction as the pinned layer 14 (e.g. upward direction). Incidentally, the minority of electrons which passed the first pinned layer 14 has the opposite spin direction to the pinned layer 14 (e.g. upward direction). The ratio of electrons with upward direction and electrons with downward direction depends on the degree of polarization of the first pinned layer 14, the majority of electrons which passed the first pinned. In the following description, it is assumed that the spin directions of the electrons are aligned mostly in the upward direction when the electrons pass through the first pinned layer 14 for convenience.

When a reproduction magnetic field H_{R} (external magnetic field) for reproducing a magnetic recording medium (not shown) is applied to the free layer 18, the magnetization direction of the free layer 18 is changed in accordance with the reproduction magnetic field. The resistance value of the magnetoresistive effect element 12 is minimum when the magnetization direction of the free layer 18 is coincident with that in the first pinned layer 14, and is maximum when the magnetization direction of the free layer 18 is opposite (anti-parallel) to that in the first pinned layer 14. When the difference of the maximum resistance value and the minimum resistance value is large, the magnetic head 10 can be provided with high sensitivity.

The electrons that have passed through the free layer 18 pass through the second spacer layer 20 that is conductive, and then travel toward the second pinned layer 22. It is considered that when the polarized electrons traverse the free layer 18, a part of their spin angular momentum is transferred to the free layer. This effect called spin transfer causes movement of the magnetization of the free layer 18. The instability of the magnetization of the free layer 18 causes spin waves which is source of noise to the magnetoresitive element 12.

In a case where an area A of a cross-section of the free layer 18 (that is perpendicular to the stacked direction) is equal to or smaller than 8000 nm², for example, it is considered that high current density of more than 10⁷A/cm² can be reached and therefore the noise caused by the spin-transfer effect becomes large.

However, it is considered that the spin-transfer effect in the free layer 18 is reduced because electrons with downward spin direction travels toward the free layer 18 from the second pinned layer 22. Thus, the oscillation of the magnetization of the free layer 18 is reduced or suppressed and therefore the noise also reduced or suppressed.

The part of magnetoresistive effect element 12 comprising: the free layer 18, the second spacer layer 20 and the second pinned layer 22 acts as a CPP-GMR (current-perpendicular-to the plane giant magnetoresistive element). It is known that the magnetoresistance ratio in CPP-GMR is proportional to the thickness of either the free layer or pinned layer. Thick CPP-GMR is not desired since it will reduce TMR effect of the bottom part of the magnetoresistive effect element 12. So it is preferable that the second pinned layer 22 is as thin as possible. However, if the second pinned layer 22 is thinner than 1 nm,it might be a non-continuous film with less efficiency. Therefore, it is preferable that the thickness t_{P2} (nm) of the second pinned layer 22 satisfy 1≦t_{P2<}4.

In the first exemplary embodiment, it is assumed for convenience that the spin directions of the majority of electrons which passed through the first pinned layer 14 has upward spin direction. However, the same level of the noise-suppressing effect can be also obtained in a case where the spin directions of the majority of electrons which passed through the first pinned layer 14 has downward spin direction. In this case, it is also considered that electrons having upward spin direction travel toward the free layer 18 from the second pinned layer 22 in which the magnetization direction is opposite (anti-parallel) to that in the first pinned layer 14.

Next, a second exemplary embodiment of the present invention is described.

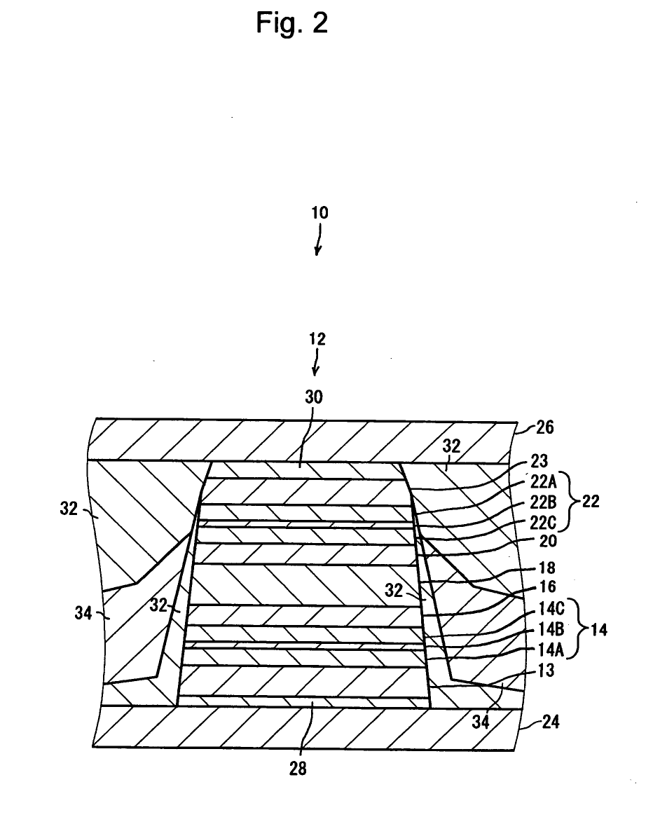

The second exemplary embodiment is a more specific example of the structure of the magnetic head 10 of the first exemplary embodiment, as shown in FIG. 2.

The magnetoresistive effect element 12 has a shape in which a width thereof becomes narrower from the first pinned layer 14 to the second pinned layer 22 gradually.

The first pinned layer 14 has a synthetic structure composed of a ferromagnetic layer 14A, a non magnetic spacer layer 14B and a ferromagnetic layer 14C are stacked in that order toward the second pinned layer 22. Incidentally, an antiferromagnetic layer 13 is deposited in contact with the ferromagnetic layer 14A of the first pinned layer 14. Since a magnetization direction of the ferromagnetic layer 14A and that in the ferromagnetic layer 14C are opposite to each other because of the antiferromagnetic coupling induced by the spacer layer 14B, a total magnetic moment of the first pinned layer 14 can be made small. Therefore, a good stability of magnetization of the first pinned layer 14 and good bias control of the free layer 18 can be achieved.

The second pinned layer 22 also has a synthetic structure composed of a ferromagnetic layer 22A, a non-magnetic spacer layer 22B, and a ferromagnetic layer 22C are stacked in that order toward the first pinned layer 14. Incidentally, an antiferromagnetic layer 23 is deposited in contact with the ferromagnetic layer 22A of the second pinned layer 22.

The magnetoresistive effect element 12 is arranged between a lower shield 24 and an upper shield 26. These shields can work as electrodes.

A buffer layer 28 is provided between the lower shield 24 and the antiferromagnetic layer 13. A cap layer 30 is provided between the antiferromagnetic layer 23 and the upper shield 26.

Magnet layers (hard bias) 34 are provided on both sides of the magnetoresistive effect element 12 in a width direction (i.e., a direction perpendicular to a flowing direction of the sense current) insulated from the magnetoresistive effect element 12 by insulating members 32 in such a manner that the magnet layers 34 lies near a portion from the first pinned layer 14 to the second spacer layer 20 of the magnetoresistive effect element 12.

In the second exemplary embodiment, it is considered that a part of electrons that have passed through the free layer 18 is reflected by the boundary between the second pinned layer 22 and the second spacer layer 20 and then travels toward the free layer 18 again, as in the first exemplary embodiment. Thus, the spin-transfer effect in the free layer 18 is reduced and oscillations of magnetization of the free layer 18 is suppressed. Therefore, a noise is also suppressed.

### SIMULATION EXAMPLE 1

Simulation was performed for the magnetoresistive effect element 12 of the first exemplary embodiment under the following conditions in order to calculate a magnetization dynamics of magnetization in the magnetoresistive effect element 12, i.e., relationship between magnitude of magnetization of the free layer 18 and time.

Supplied current: 2 (mA)

Cross-sectional shape of the magnetoresistive effect element 12 (shape of a cross-section perpendicular to the stacked direction): Rectangular shape

Length of a shorter side of the above cross-section: 80 (nm)

Length of a longer side of the above cross-section: 100 (nm)

Thickness of the first pinned layer 14: 3 (nm)

Saturation magnetization of the first pinned layer 14: 700 (emu/cm³)

Thickness of the free layer 18: 3 nm ( ) (nm)

Anisotropy energy of the free layer 18: 5×10⁴ erg/cm³

Thickness of the second pinned layer 22: 4 (nm)

Saturation magnetization of the second pinned layer 22: 800 (emu/cm³)

Bias magnetic field: 250 (Oe)

Applied magnetic field: −60 (Oe) (in a direction opposite to the magnetization direction of the first pinned layer 14) exchange stiffness for the first pinned layer 14, the free layer 18 and the second pinned layer 22 is: 1.25 10⁻⁶ erg/cm.

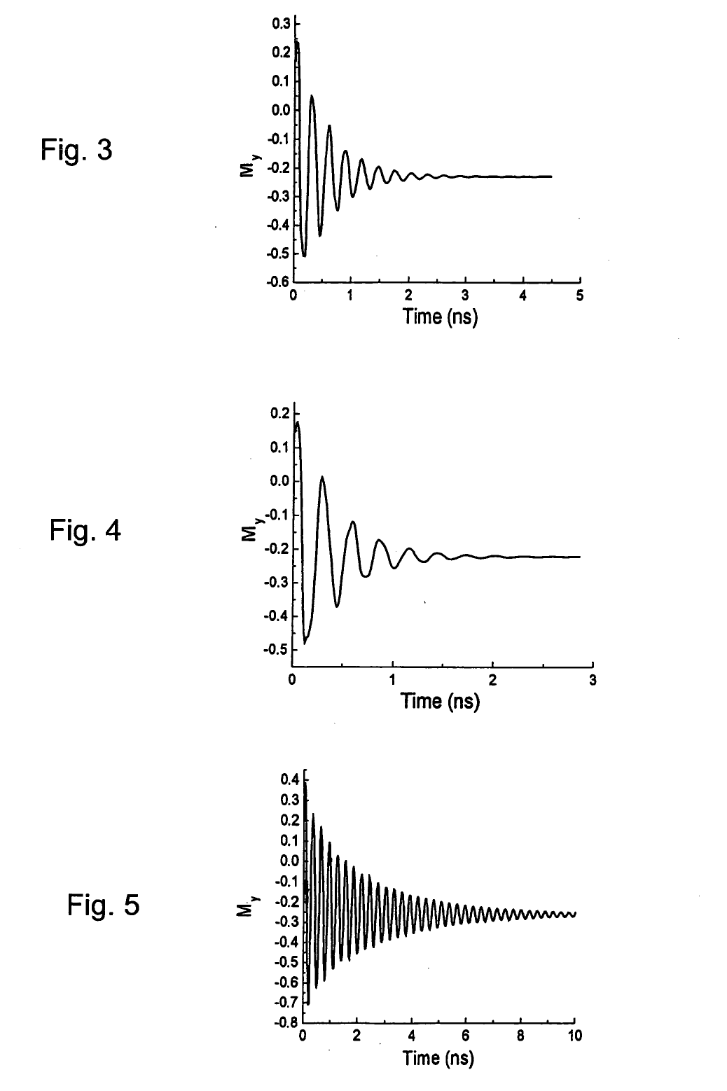

FIG. 3 shows a graph of a relationship between the magnitude of magnetization of free layer 18 in direction perpendicular to air bearing surface (ABS) and time.

As shown in FIG. 3, it was confirmed that the magnetization of the free layer 18 is stabilized and converges to its equilibrium state within 3 ns in the magnetoresistive effect element 12 of Simulation Example 1. This means there is no spin transfer noise due to oscillation of magnetization of the free layer 18 for 3 ns. Under the conditions of Simulation Example 1, it was assumed that the number of electrons which travel to the free layer 18 from the second pinned layer 22 and have spin direction opposite to that of electrons which travels to free layer 18 from the first pinned layer 14 is about 50% with respect to the number of electrons which travels to free layer 18 from the first pinned layer 14.

### SIMULATION EXAMPLE 2

In contrast with Simulation Example 1 described above, simulation was performed in order to calculate the relationship between magnitude of magnetization and time in the free layer 18 of the magnetoresistive effect element 12 setting the thickness of the second pinned layer 22 and the saturation magnetization in the second pinned layer 22 as follows. The other conditions are the same as those in Simulation Example 1.

Thickness of the second pinned layer 22: 7 (nm)

Saturation magnetization of the second pinned layer 22: 1200 (emu/cm³)

As shown in FIG. 4, it was confirmed that time required for convergence of magnetization of the free layer 18 was shorter in the magnetoresistive effect element 12 of Simulation Example 2 than in the magnetoresistive effect element 12 of Simulation Example 1. The magnetization stability time was converged within 2 ns in the magnetoresistive effect element 12 of Simulation Example 1. Under the condition of Simulation Example 2, it was assumed that the number of electrons which travel to the free layer 18 from the second pinned layer 22 and have spin direction opposite to that of electrons which travels to free layer 18 from the first pinned layer 14 is about 50% with respect to the number of electrons which travels to free layer 18 from the first pinned layer 14.

### SIMULATION EXAMPLE 3

In contrast with Simulation Example 1 described above, simulation was performed for a magnetoresistive effect element in which the second spacer layer 20 and the second pinned layer 22 were omitted, in order to calculate the relationship between magnitude of magnetization in the free layer 18 and time. Except for the above, Simulation Example 3 was performed in the same manner as that of Simulation Example 1.

As shown in FIG. 5, it was confirmed that the convergence time required for the equilibrium of the magnetization of free layer 18 was longer in the magnetoresistive effect element of Simulation Example 3 than in the magnetoresistive effect element 12 of Simulation Example 1. The convergence time in Simulation Example 3 was more than 10 ns.

The present invention can be applied to a magnetic head for use in a hard disk drive or the like.

What is claimed is:

1. A magnetic head comprising a magnetoresistive effect element,
the magnetoresistive effect element including:
a first pinned layer;
a first spacer layer made of an insulating material;
a free layer having a magnetization direction changeable in accordance with an external magnetic field;
a second spacer layer that is conductive; and a second pinned layer, these layers are stacked in that order, wherein:
a magnetization direction of the first pinned layer is substantially fixed along a direction perpendicular to a stacked direction in which these layers are stacked; and
a magnetization direction of the second pinned layer is fixed to be opposite to the magnetization direction of the first pinned layer.

2. The magnetic head according to claim 1, wherein
the second spacer layer contains at least one element selected from the group consisting of Cu, Ag, Au, and Cr.

3. The magnetic head according to claim 1, wherein
a thickness tₚ₂ of the second pinned layer satisfies 1 nm≦tₚ₂≦4 nm.

4. The magnetic head according to claim 2, wherein a thickness tₚ₂ of the second pinned layer satisfies 1 nm≦tₚ₂≦4 nm.
